(19) United States
(12) Patent Application Publication
(10) Pub. No.: US 2012/0089960 A1
(43) Pub. Date: Apr. 12, 2012

(54) EXTENSIBLE COLLABORATIVE SOFTWARE MODELING

(75) Inventors: Nenad MEDVIDOVIC, Manhattan Beach, CA (US); Jae Young BANG, Los Angeles, CA (US); Daniel POPESCU, Pasadena, CA (US); George EDWARDS, West Hollywood, CA (US); Srinivas PADMANABHUNI, Bangalore (IN); Girish Maskeri RAMA, Bangalore (IN); Naveen KULKARNI, Bangalore (IN)

(73) Assignee: UNIVERSITY OF SOUTHERN CALIFORNIA, Los Angeles, CA (US)

(21) Appl. No.: 13/271,008

(22) Filed: Oct. 11, 2011

Related U.S. Application Data
(60) Provisional application No. 61/392,190, filed on Oct. 12, 2010.

(51) Int. Cl. G06F 9/44

(52) U.S. Cl. 717/105; 717/104

(57) ABSTRACT

Multiple architects may concurrently create and modify a model of computer software, each on their own client at a different location. Each change that is made to a model is forwarded to a server for analysis. The server may determine whether the change creates a conflict. If no conflict is detected, the change may be approved, saved, and propagated by the server to all of the other clients that are working on the same model. If a conflict is detected, on the other hand, the change may not be approved by the server. The server may instead provide notice of the conflict.

### CROSS-REFERENCE TO RELATED APPLICATION

This application is based upon and claims priority to U.S. provisional patent application 61/392,190, entitled “CODESIGN: A HIGHLY EXTENSIBLE COLLABORATIVE SOFTWARE MODELING FRAMEWORK,” filed Oct. 12, 2010, attorney docket number 028080-0611. The entire content of this application is incorporated herein by reference.

### BACKGROUND

1. Technical Field

This disclosure relates to software modeling and, in particular, to software models that are concurrently designed and edited by different persons at different locations.

2. Description of Related Art

In recent years, many technology companies have transferred significant portions of their software development activities to emerging economies, such as India and China. At the same time, many stakeholders, such as customers and requirements engineers, remain in developed countries. As a result, companies have created global software development teams in which engineers are separated by large geographic distances.

While the economic advantages of distributed software development are real, communication challenges may impede the full realization of these advantages. Geographic separation may drastically reduce communication among coworkers. Irregular and ineffective communication may prevent shared understanding of problems and solutions, and can lead to redundant efforts during software development.

Global software teams have relied on traditional integrated development environments (IDEs) that were developed for co-located development teams, along with software configuration management (SCM) systems. SCM tools, such as CVS and Subversion, allow engineers to work on software artifacts independently and with reduced planning and coordination because they automatically merge modifications and detect conflicting changes. However, concurrent SCM systems may not detect conflicts until the engineers “check in” the changes, by which point there may have been efforts that were unnecessary or useless. Furthermore, conflicts may be more difficult and time-consuming to resolve at this late stage.

To detect conflicts and avoid costly conflict resolution, collaborative IDEs have become a popular way to provide engineers with awareness of the concurrent development activities of coworkers. Most collaborative IDEs detect conflicting, concurrent modifications to the same artifact—such as the same file—and provide real-time notifications of these obvious, direct conflicts. A more limited number of collaborative IDEs also detect indirect conflicts that may require more rigorous analysis. For example, if one engineer changes the implementation of a component while another engineer concurrently modifies the component's interface, an indirect conflict could result.

Current collaborative IDEs focus on distributed programming. Other critical development tasks, particularly architecture design and modeling, are not readily supported, even though these activities require frequent interactions among team members and short feedback cycles. As a result, geographically-distributed software architects may still create and edit their models in traditional modeling environments and check-in their changes to a repository using an SCM system. This may result in all the same problems noted above that collaborative IDEs helped to solve.

### SUMMARY

Multiple architects may concurrently create and modify a model of computer software, each on their own client at a different location. Each change that is made to a model may be concurrently detected and forwarded to a server for analysis. The server may determine whether the change creates a conflict. If no conflict is detected, the change may be approved, saved, and propagated by the server to all others clients that are also working on the same model. If a conflict is detected, on the other hand, the change may not be approved by the server. The server may instead provide notice of the conflict.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates multiple software modeling clients and an associated conflict detection software modeling server.

FIG. 2 illustrates an example of the conflict detection software modeling server illustrated in FIG. 1.

FIG. 3 illustrates an example of one of the software modeling clients illustrated in FIG. 1.

FIG. 4 illustrates another example of the conflict detection software modeling server and one of the software modeling clients illustrated in FIG. 1.

FIG. 5 illustrates an example of a conflict rule that may be programmed in the server illustrated in FIG. 4.

FIG. 6 illustrates an example of a screen that may be generated during the initialization of the conflict detection software modeling server illustrated in FIG. 4.

FIGS. 7A and 7B illustrates examples of client log-in screens that may be generated during the login of a first and a different second client of the type illustrated in FIG. 4, respectively.

FIGS. 8A and 8B illustrate examples of screens that may be generated after the logins illustrated in FIG. 7 on the respective clients.

FIG. 9 illustrates an example of a screen that may be displayed by the conflict detection software modeling server illustrated in FIG. 4 after the logins illustrated in FIGS. 7A and 7B.

FIG. 10A illustrates an example of a screen on the first client, displaying a model of software after it is received from the server illustrated in FIG. 4, including a design element within this model. FIG. 10B illustrates an example of a screen on the second client, displaying the same model of software after it is received from the server illustrated in FIG. 4, including the design element within this model.

FIG. 11A illustrates the screen on the first client, after an architect on the first client has moved the position of the design element. FIG. 11B illustrates the screen on the second client after the movement of the design element that was made by the architect of the first client has been determined by the conflict detection software modeling server illustrated in FIG. 4 not to create a conflict.

FIG. 12A illustrates the screen on the first client after an architect has removed the design element. FIG. 12B illustrates the screen on the second client, before the deletion of the design element that was removed by the architect on the first client has been determined not to create a conflict by the server illustrated in FIG. 4.

FIG. 13A illustrates a conflict notification on the screen of the first client after the architect on the second client moved the removed design element. FIG. 13B illustrates a conflict notification on the screen on the second client after the architect on the second client moved the removed design element.

FIG. 14 illustrates a report that the server that is illustrated in FIG. 4 may display after detection of the conflict illustrated in FIGS. 13A and 13B.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

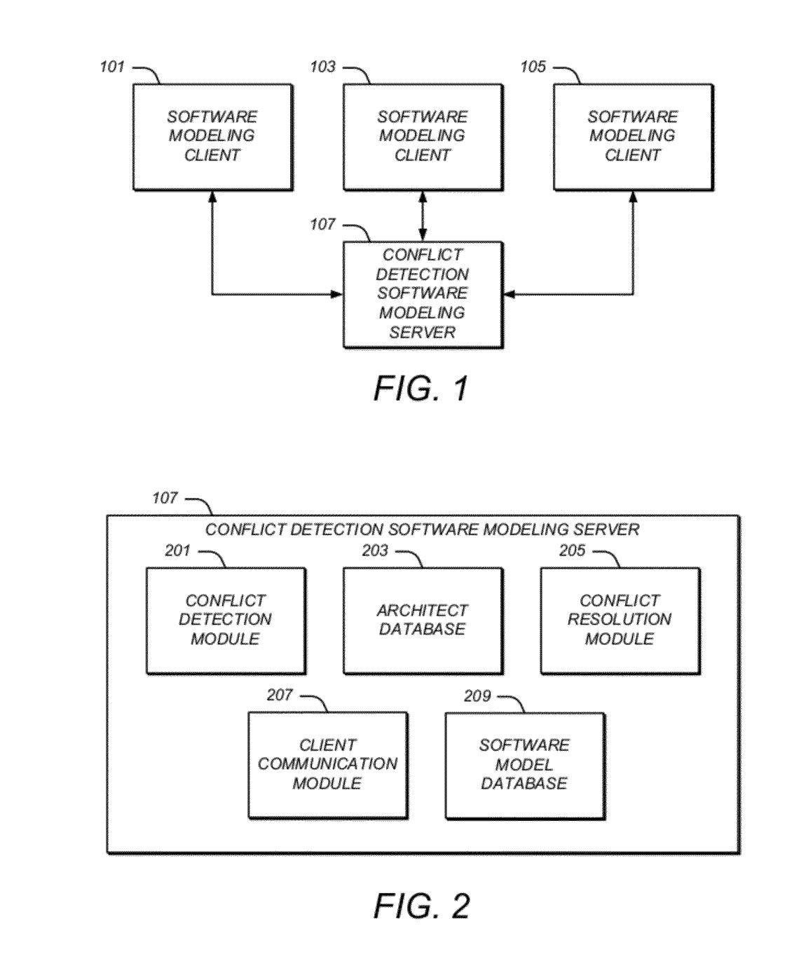

FIG. 1 illustrates multiple software modeling clients 101, 103, and 105 and an associated conflict detection software modeling server 107. As illustrated in FIG. 1, the multiple software modeling clients 101, 103, and 105 may each communicate with the conflict detection software modeling server 107. The software modeling clients 101, 103, and 105 may communicate with the conflict detection software modeling server 107 over a computer network, such as over the Internet, a local area network, a wide area network, or a combination of these. Although only three clients are illustrated in FIG. 1, there may be a different number, such as a smaller or larger number.

Each software modeling client 101 may design and edit the same model of software under the instructions of a software design architect. Each software modeling client may also allow an architect to work on other software models, either alone or concurrently with architects working on one or more of the other clients.

The model of software is an artifact that captures some or all of the design decisions that comprise a software system's architecture or design.

Each change to a model that is made by an architect may be communicated to the conflict detection software modeling server 107. In turn, the conflict detection software modeling server 107 may determine whether the change creates a conflict. If not, the conflict detection software modeling server 107 may save the approved change and notify the clients that did not make the change of the approved change, so that they may update their copy of the model accordingly.

If a conflict is detected, on the other hand, the conflict detection software modeling server 107 may communicate information about this conflict to the client that made the change, as well as possibly to one or more of the other clients, such as the other client or clients that are involved with the conflict. The client that made the change may then remove the change. The architects that are involved with the conflict may then communicate with one another to resolve the conflict.

In an alternate configuration, the client that makes the change may be configured to defer implementation of the change until after receiving notice from the conflict detection software modeling server 107 that the change does not create a conflict. In this configuration, the conflict detection software modeling server 107 may be configured to notify the client that made the change that it does not conflict, as well as to save the change and notify the other clients of the approved change.

FIG. 2 illustrates an example of the conflict detection software modeling server 107 illustrated in FIG. 1. As illustrated in FIG. 2, the conflict detection software modeling server 107 may include a conflict detection module 201, an architect database 203, a conflict resolution module 205, a client communication module 207, and a software model database 209. The conflict detection software modeling server 107 may include additional components or not all of the components that have been described.

The client communication module 207 may be configured to communicate with the clients 101, 103, and 105 over a computer network, such as over the Internet, a local area network, a wide area network, or a combination of these. The communications may include receiving information about changes to a model of computer software. Information about each change may come from one of multiple software modeling clients that are designing the model, such as the software modeling clients 101, 103, or 105. The client communication module 207 may include a network interface card and related hardware and software.

The conflict detection module 201 may be configured to determine whether each requested change that is received by the client communication module 207 would cause a conflict. This determination may be based on a set of programmable rules. The conflict detection module 201 may be configured to determine that a change would cause a conflict, for example, when the change would cause a synchronization conflict, a syntactic conflict, and/or a semantic conflict. Descriptions of each of these types of conflict is provided below.

The conflict detection module 201 may include multiple conflict detection sub-modules. Each sub-module may be configured to determine whether a requested change would cause a conflict of a particular type. The conflict detection module 201 may be configured to aggregate the results from the conflict detection sub-modules.

The conflict detection module 201 may be configured to cause the client communication module 207 to respond to the information about each change that it receives.

When the conflict detection module 201 determines that a change would not cause a conflict, the conflict detection module 201 may be configured to cause the client communication module 207 to communicate information about the change to the software modeling clients that did not send the information about the change to the conflict detection software modeling server. The information to the other clients may include a description of the change, the architect who created the change, and the state of the system model present at the location of the architect who created the change at the moment the change was created. The conflict detection module 201 may be configured to cause the client communication module 207 to also communicate information about the change to the software modeling client that did send the information about the change. The conflict detection module 201 may also be configured to cause information about the approved change to be stored in the software model database 209.

When the change would cause a conflict, on the other hand, the conflict detection module 201 may be configured to cause the client communication module 207 to communicate to the software modeling client that sent the information about the change that the change causes a conflict. The communication may include information identifying the architects involved with the conflict, the elements of the model that are involved with the conflict, and the actions that caused the conflict. This communication may also be sent to other clients, such as the other client or clients that are involved with the conflict.

The architect database 203 may be configured to store information identifying architects and/or clients that have registered with the conflict detection software modeling server 107 to modify one or more models. The architect database 203 may include information identifying each registered architect and/or client and each model for which the architect and/or client has been registered.

The conflict resolution module 205 may be configured to automatically resolve some or all conflicts in accordance with rules that may be programmable. For example, the conflict resolution module 205 may be configured to resolve a synchronization conflict by giving preference to the conflicting feature that was first entered or that was entered by the senior architect. If the conflict resolution module 205 is able to resolve a conflict, the conflict resolution module 205 may be configured to cause the client communication module 207 to communicate information about the resolved and now approved change to the software modeling clients that did not send the information about the change, as well as to the client that did send the information.

The software model data base 209 may be configured to store a copy of the current state of each model, with all approved changes, and to download this to any client that requests it. It may also be configured to store a transaction history of the changes to each model.

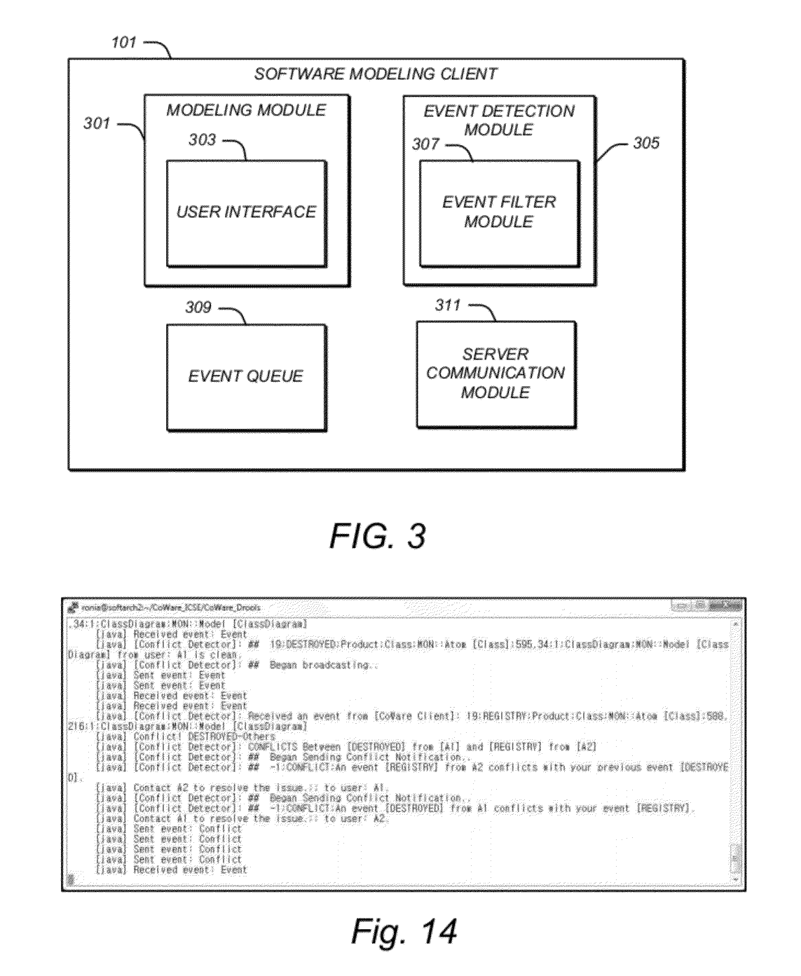

FIG. 3 illustrates an example of the software modeling client 101 illustrated in FIG. 1. As illustrated in FIG. 3, the software modeling client 101 may include a modeling module 301 containing a user interface 303, an event detection module 305, an event queue 309, an event filter module 307, and a server communication module 311 The software modeling client 101 may contain additional modules or not all of these modules.

The modeling module 301 may be configured to enable an architect to design and edit a model of computer software. Examples of the modeling module 301 are provided below.

The user interface 303 may be configured to allow the architect to view the model, to request changes to the model, and to view the model with changes made to it. The user interface 303 may include any type of user interface device, such as a display, touch screen, keyboard, pointing device, microphone, and/or sound transducer.

The event detection module 305 may be configured to detect each change to the model that the architect requests through the use of the user interface 303 in the modeling module 301. To facilitate this, the modeling module 301 may include one or more APIs that are invoked by the modeling module 301 each time an architect requests a change to the model. These APIs may be configured to pass information about the change request, such as an identifier of the target modeling element that is being modified, the type of action that is made, the previous value of the element, the new value of the element, and information about the parent of the target element.

The event detection module 305 may include an event filter module 307. The event filter module 307 may be configured to filter events that are detected by the event detection module 305 so as to eliminate one or more types of events according to filter criteria from those about which information is communicated to the remote conflict detection software modeling server 107. The filter criteria may be configured to be user-programmable.

Events that are detected by the event detection module 305 and filtered by the event filter module 307 may be passed to the event queue 309 for temporary storage. The event queue 309 may be configured to temporarily store information about each change until information about the change is communicated to the conflict detection software modeling server 107. This may prevent disruption of the conflict verification process that might otherwise be caused by a temporary lapse in the communication between the software modeling client 101 and the conflict detection software modeling server 107 and/or by a temporary failure of the conflict detection software modeling server 107.

The server communication module 311 may be configured to communicate with the clients 101, 103, and 105 over a computer network, such as over the Internet, a local area network, a wide area network, or a combination of these. The server communication module 311 may include a network interface card and related hardware and software.

The event detection module 305 may be configured to cause the server communication module 311 to communicate information about each change to the remote conflict detection software modeling server 107. The information may include information identifying the model, the change to the model, the person making the change, and the time of the change.

The server communication module 311 may be configured to receive different types of notifications from the conflict detection software modeling server 107.

One type of notification that the server communication module 311 may be configured to receive may indicate that the previously-communicated change caused a conflict. The notification may include information identifying the architects that are involved with the conflict, elements in the model that would conflict, and the actions that cause the conflict. When this type of notification is received, the modeling module 301 may be configured to remove the change from the model. The architect may then attempt to manually resolve the conflict, which may include communicating with one or more other architects that may be involved with the conflict.

Another type of notification that the server communication module 311 may be configured to receive may indicate that another client has made an approved change to a model. The notification may include information identifying the model, the change, the architect that made the change, and the time of the change. The modeling module 301 may be configured to cause the change that is the subject of each such notification to be made. Again, this may be facilitated by an appropriate API in the modeling module 301.

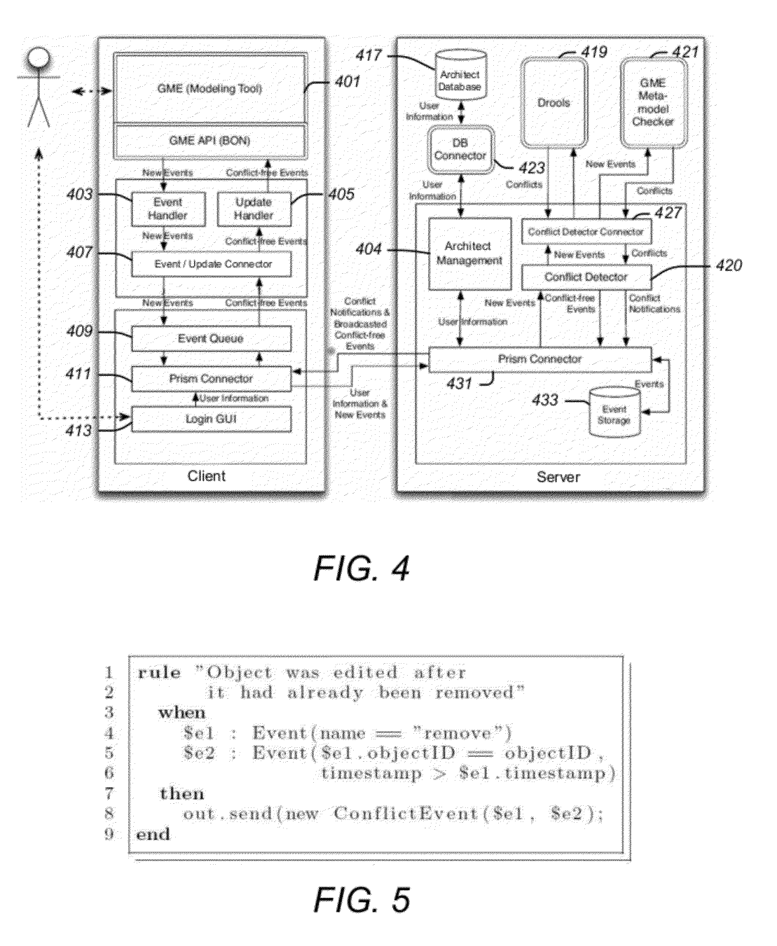

FIG. 4 illustrates another example of one of the software modeling clients and the conflict detection software modeling server illustrated in FIG. 1.

The software modeling client illustrated in FIG. 4 may be configured to perform the functions of the client 101 and may include a GME modeling tool 401, an event handler 403, an update handler 405, an event/update connector 407, an event queue 409, a Prism connector 411, and a login GUI 413.

The GME modeling tool 401 and the update handler 405 may be configured to perform the functions of the modeling module 301; the event handler 403 may be configured to perform the functions of the event detection module 305 and the event filter module 307; and the event queue 409 may be configured to perform the functions of the event queue 309. The client components illustrated in FIG. 4 may also be configured to perform additional and/or different functions, as described below.

Correspondingly, the server illustrated in FIG. 4 may be configured to perform the function of the server 107 and may include an architect database 417, a Drools conflict engine 419, a GME meta-model checker 421, a database connector 423, an architect management module 425, a conflict detector connector 427, a conflict detector 420, a Prism connector 431, and event storage 433. The Drools conflict engine 419, the GME meta-model checker 421, and the conflict detector 420 may be configured to collectively perform the functions of the conflict detection module 201; the architect database 417 may be configured to perform the functions of the architect database 203; and the event storage 433 may be configured to perform the functions of the software model database 209. Each of the components illustrated in the server in FIG. 4 may be configured to perform additional or different functions, as described below.

The event queue 409, the Prism connector 411, the login GUI 413, the architect management module 425, the conflict detector connector 427, the conflict detector 420, the Prism connector 431, and the event storage 433 may be configured to interact via lightweight middleware.

The design illustrated in FIG. 4 may implement an event-based architecture in which highly-decoupled components may exchange messages via implicit invocation, allowing flexible system composition and adaptation. This event-based architecture may be coupled with an API that provides explicit extension points for plugging in conflict detection engines, such as the Drools conflict engine 419 and the GME meta-model checker 421. This may allow different clients (e.g., a UML modeling tool or a finite state machine modeling tool) to be paired with the most appropriate consistency checkers. It also may allow multiple consistency checkers to be used in concert and for their conflict check results to be aggregated, in order to handle different types of modeling inconsistencies.

Off-the-shelf conflict detection engines may be used, such as the Drools conflict engine 419 (from the JBoss community), the GME meta-model checker 421, and/or a Jess conflict detection engine from IBM.

The types of conflicts that can occur during collaborative distributed architectural modeling may be classified in different ways. One such classification approach is described below. The architecture and implementation of the design illustrated in FIG. 4 is also described below in more detail, with a focus on an extensibility mechanism.

### Design-Time Conflicts

When designing distributed collaborative systems, it may be helpful to understand the potential issues and conflicts caused by modeling events that are generated simultaneously in remote locations. Two categories of issues that may occur in collaborative software modeling over the network are: parallel modification and modeling conflicts.

Parallel modification may occur when multiple architects modify the same modeling object or multiple objects that are very close in a model, e.g., an object and its parent. Parallel modification need not manifest itself as a conflict. However, detecting it and notifying the architects may be crucial as a warning to exercise caution and avoid future conflicts. For example, even though two simultaneous modifications to an object and its parent may be consistent with one another, each of the architects making one of those modifications may be unaware of the other architect's actions and may be more likely to make subsequent changes that will, in fact, result in a conflict. The conflict detection module 201 may be configured to detect changes from architects regarding closely related software elements and issue notifications of these changes to the architects. Such notifications may include the information regarding the system model elements that are modified by the change as well as their parent elements.

A conflict may include an issue that is engendered by synchronization latency, that is, when one architect makes a design decision that cannot be reconciled with another, previously made design decision, but that has not yet been synchronized with the architect's local instance of the model. Because of their nature, decentralized systems may not always be perfectly synchronized, inducing the architects to make potentially erroneous decisions.

Modeling conflicts may be classified into three types based on rules that system modeling events violate: (1) synchronization, (2) syntactic, and (3) semantic conflicts.

Synchronization conflicts can be resolved with little or no human intervention. For example, if an architect removes a class from a system model and another architect decides to add an attribute to the same class before the removal event arrives, those two events would result in inconsistent states between the two instances. This type of conflict might not happen if the two architects were in the same workspace, since the removal event might be instantly “recorded” and the class would no longer be there for the second architect to modify. Synchronization conflicts may be the simplest of the three conflict types and can be detected and resolved efficiently and scalably.

Syntactic conflicts violate a modeling tool's or language's meta-model constraints. Suppose, e.g., that an architect connects an instance a1 of class A with an instance b1 of class B and, before the connection addition event arrives, another architect connects a1 and a new instance b2 of class B. If the cardinality constraint of the meta-model allows class A to have an association to only one instance of class B, this becomes a conflict that would likely not have occurred if the two architects were co-located. When the modeling tool illustrated in FIG. 4 receives the second event, the tool's meta-model constraint checker will detect an error. Alternatively, the tool could experience an unexpected crash if it does not support syntactic conflict detection. Either way, unlike the synchronization conflicts, the resolution of syntactic conflicts may require human intervention.

Unlike the synchronization and syntactic conflicts, semantic conflicts reflect violations in the intended, implicit rules by which a system's model should abide. For example, a collaboratively completed design in a given architecture description language (ADL) may have no irreconcilable events on the same model elements (i.e., no synchronization conflicts) and no violations of the ADL's grammar (i.e., no syntactic conflicts). However, the model may be modified in a way, for example, that violates rules of the underlying design style. As a simple example, assume that the intended style is client-server. An architect may model component C1 to make direct requests of component C2 in the system; the implication of this is that C1 is a client and C2 is a server. Another architect may, however, model component C2 to make direct requests of component C1; the implication of this interaction dependency is that C1 is, in fact, a server and C2 a client. Hence, the same component is erroneously modeled both as a client and a server. Again, the language in which the model is specified (e.g., UML) may not consider this a conflict. In order to be properly checked, this semantic rule may have to be specified externally (e.g., in the Object Constraint Language, or OCL). As with syntactic conflicts, semantic conflicts such as the one illustrated above may be highlighted by a tool such as illustrated in FIG. 4, but may not be resolved without human intervention.

### Architecture and Integration

As illustrated in FIG. 4, the system may have an architecture and mechanism for enabling its integration with off-the-shelf (OTS) conflict detection modules. The design may support integration with a variety of modeling languages and environments. Since modeling languages differ in the way their syntax and semantics are defined, the design may allow distributed architecture teams to use their own specific conflict detection engines, rather than attempting to provide a general-purpose conflict detection engine. An example use case scenario of a collaborative conflict that helps to illustrate this architecture is described below. Conflict detection extension points and integration and customization of two OTS components for conflict detection are also described below. Other such components, such as Jess, may be integrated in the same manner.

### Architecture

The design may use a modeling tool-specific adapter to capture design decisions, in the form of model updates, from architecture modeling tools. Each model update may be subsequently encapsulated within a design event and may be transferred through the middleware infrastructure. A client may be installed at each architect location to communicate with the server, which may be running the conflict detector 420. The design events may be forwarded from the event handler 403 and the event/update connector 407 through the event queue 409, and Prism connector 411 to the server and then to the conflict detector 420.

The conflict detector 420 may be configured to evaluate each event to determine whether it conflicts with any previous event(s) by requesting all plugged-in conflict detection engines to analyze the event. The server may broadcast each event back to all of the clients if and only if all plugged-in conflict detection modules affirm that the design event does not cause any conflict. However, if a conflict exists, the server may attempt to resolve it by itself and/or to send alerts to the architects involved in the conflict using a conflict notification message.

Off-the-shelf software components may be used, such as the GME Modeling Tool 401, a software modeling tool from Vanderbilt University; the Drools conflict engine 419, a rule-based business logic integration platform developed by the JBoss community; and the Prism connectors 411 and 431 which are part of Prism-MW, an event-based middleware platform created at USC. The communication between all of the modules in the server may also rely upon PrismMW.

The Event Handler 403 and the event/update connector 407 may be used with the GME Modeling Tool 401 to capture design decisions made by architects using the GME Modeling Tool 401 via native API in the GME Modeling Tool 401. These may be packaged within Prism-MW events by the Event Handler 403 and transferred to the event queue 409 and, in turn, the Prism connector 411. The Prism connector 411 may receive the events and utilize Prism-MW's connector facilities to send them to the conflict detector 420 in the conflict detection software modeling server.

In this particular configuration, the Drools conflict engine 419 may be used to detect synchronization conflicts and the GME's native meta-model checker 421 may be used to detect syntactic conflicts. A GME's OCL constraint checker (not shown) may also be used to detect semantic conflicts.

As a simple scenario of conflict detection, suppose an architect A1 deletes a design element e1 from her model in the GME modeling tool 401. Once the Prism-MW event generated by this design decision arrives at the conflict detector 420, each plugged-in conflict detection engine will analyze it. The GME meta-model checker 421 and the Drools conflict engine 419 may respond that the event does not cause a conflict. Both engines may also store the event temporarily or permanently, depending on the circumstances. The Prism connector 431 then broadcasts the event back to all of the other clients. There may be no need to broadcast the event back to A1 who requested the change, as A1 already knows of it.

Suppose that architect A2 changes the geometric location of e1 before the remote deletion event is applied to her local model data. The event is sent to the conflict detector 420 in the same way. This time, however, the Drools conflict engine 419 may detect that the model update is to an object that no longer exists. In this instance, the Prism connector 431 may not broadcast the location event, since the intentions of the two architects conflict. The Prism connector 431 may instead notify the architects that are involved with the conflict to ensure that they are aware of the situation. They may then correct it through discussions with each other.

The event storage 433 in FIG. 4 may be configured to store each event that is received, as well as a copy of the latest version of each model that is registered with the server, based on events that have been determined not to create a conflict.

### Extending the Design

The design's support for integrating and customizing conflict detection engines uses two example conflict engines: the Drools conflict engine 419 and the GME meta-model checker 421.

Detecting synchronization conflicts may use the Drools conflict engine 419: The Drools conflict engine 419 is a production rule system that can be used to detect complex events. The Drools conflict engine 419 may evaluate whether a production rule triggers based on the facts it receives and computes. A production rule may follow a simple pattern: when <condition> then <action>. A complex event (e.g., a synchronization conflict) may be a pattern-based abstraction of other events and can also be evaluated using production rule systems. Whenever the customized Drools conflict engine 419 receives an event to evaluate, it may add the event to its working memory and evaluate all synchronization conflict rules.

FIG. 5 illustrates an example of a conflict rule that may be programmed in the server illustrated in FIG. 4. This rule may detect when one client changes a model element that had previously been deleted by another client. The system is able to detect modifications to the same model elements because all distributed instances of a model element may have a single object ID in every client.

Detecting syntactic and semantic conflicts may use the GME meta-model checker 421. In the configuration described thus far, the GME modeling tool 401 may be used as the system modeling environment. Hence, this configuration's syntactic and semantic conflict detection engines need to understand the syntax and semantic constraints of GME models. To ensure that syntactic and semantic conflicts are detected early, the relevant components of the GME modeling tool 401 may be reused and integrated. The GME meta-model checker 421 may contain the logic that manages the data model and checks whether executing a received event keeps the data model consistent with its meta-model.

Other conflict engines may be integrated. To integrate a different OTS conflict engine, an adapter connector may be used to translate events into invocations of the conflict engine's API and to tie the results returned by the conflict engine back to the conflicting events. The conflict detector 420 may check each event that the server receives from the clients. The conflict detector 420 may be unaware of the syntax and the semantic constraints of the edited models. It therefore may not itself check whether an event causes a conflict, but instead forward each event to the conflict detector connector 427.

The conflict detector connector 427 may distribute the event to each integrated conflict detection engine, which in turn may evaluate the received event in parallel. The results may be returned to the conflict detector connector 427 and evaluated by the conflict detector 420, which may notify the appropriate clients in the case of one or more conflicts.

Example steps of a conflict detection process that may be implemented with the system illustrated in FIG. 4 are now illustrated and described. Some of these steps may not be performed by some systems, while some systems may perform additional and/or different steps.

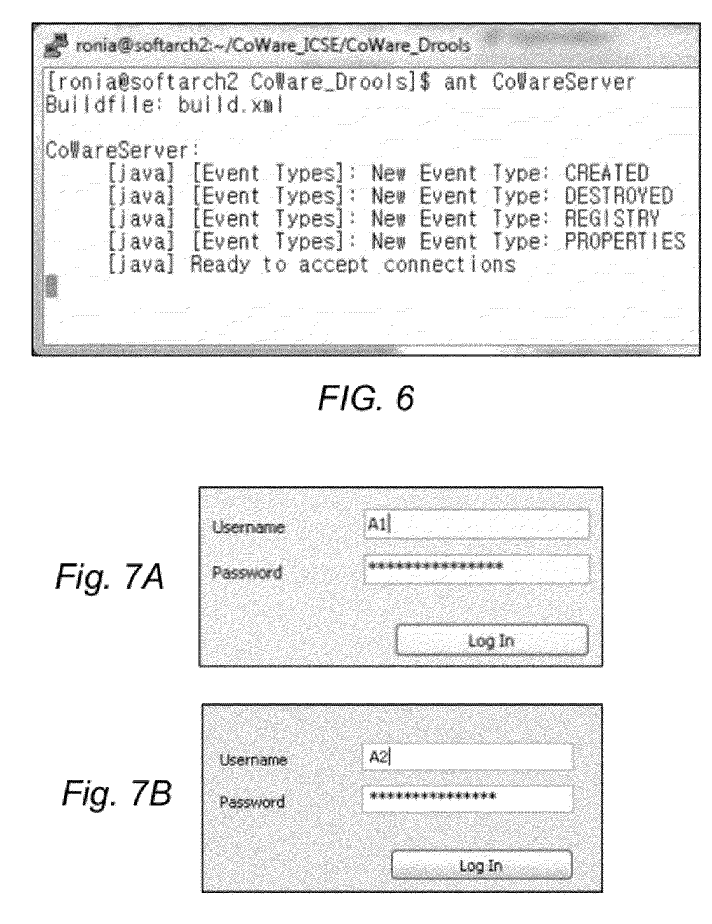

FIG. 6 illustrates an example of a screen that may be generated during the initialization of the conflict detection software modeling server illustrated in FIG. 4. This screen illustrates the conflict detector 420 displaying types of events (changes) that it will not analyze for conflicts and the server displaying that is ready to accept new connections from clients.

FIGS. 7A and 7B illustrates examples of client log-in screens that may be generated during the login of a first and a different second client of the type illustrated in FIG. 4, respectively. Although not illustrated, the log-on dialog box may also enable an architect to select one of several models that the architect is developing. The login GUI 413 may be configured to generate these screens and to otherwise manage the login from the client side. The architect management module 404 may correspondingly be configured to manage the login from the server side in association with the architect database 417 and the database connector 423.

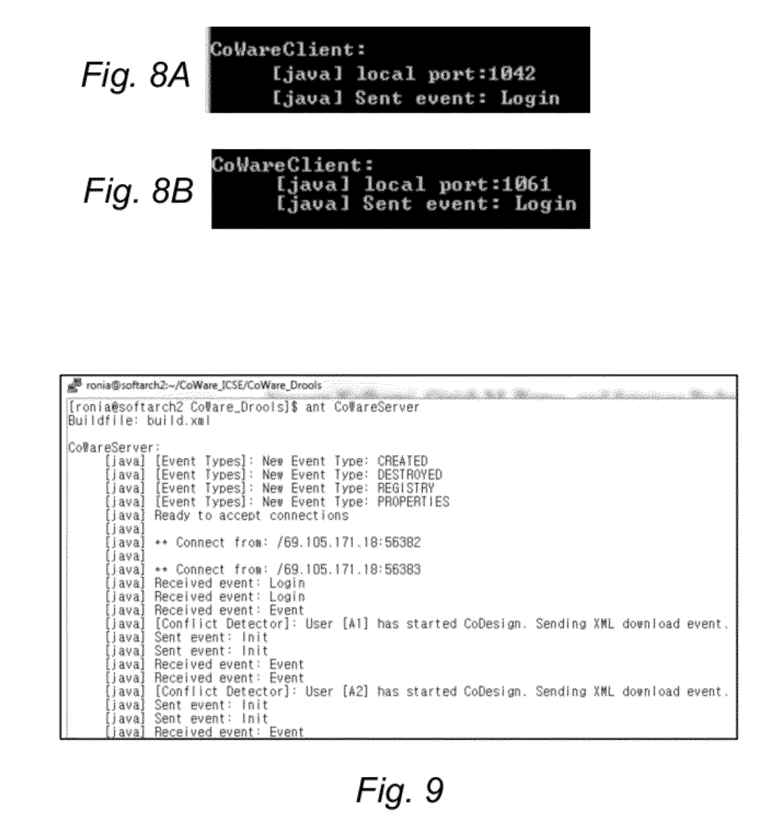

FIGS. 8A and 8B illustrate examples of screens that may be generated after the logins illustrated in FIG. 7 on the respective clients. These screens illustrate that two clients have sent initial login information to the server. After a login is complete, a complete copy of the most recent version of the model that is being edited may be downloaded from the event storage 433 in the conflict detection software modeling server to the client that has logged in. A local copy of that model may instead be used.

FIG. 9 illustrates an example of a screen that may be displayed by the conflict detection software modeling server illustrated in FIG. 4 after the logins illustrated in FIGS. 7A and 7B. The screen illustrates the events received from the clients, and the server sending a notice to the clients to download the current model data.

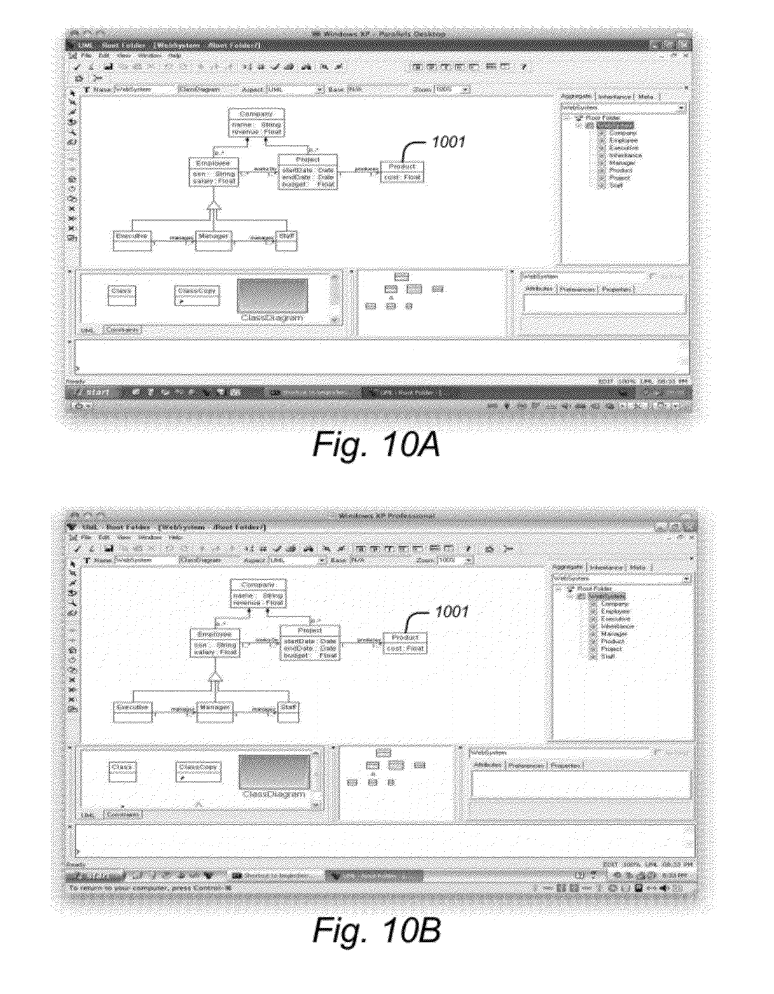

FIG. 10A illustrates an example of a screen on the first client, displaying a model of software after it is received from the server illustrated in FIG. 4, including a design element 1001 within this model.

FIG. 10B illustrates an example of a screen on the second client, displaying the same model of software after it is received from the server illustrated in FIG. 4, including the design element 1001 within this model.

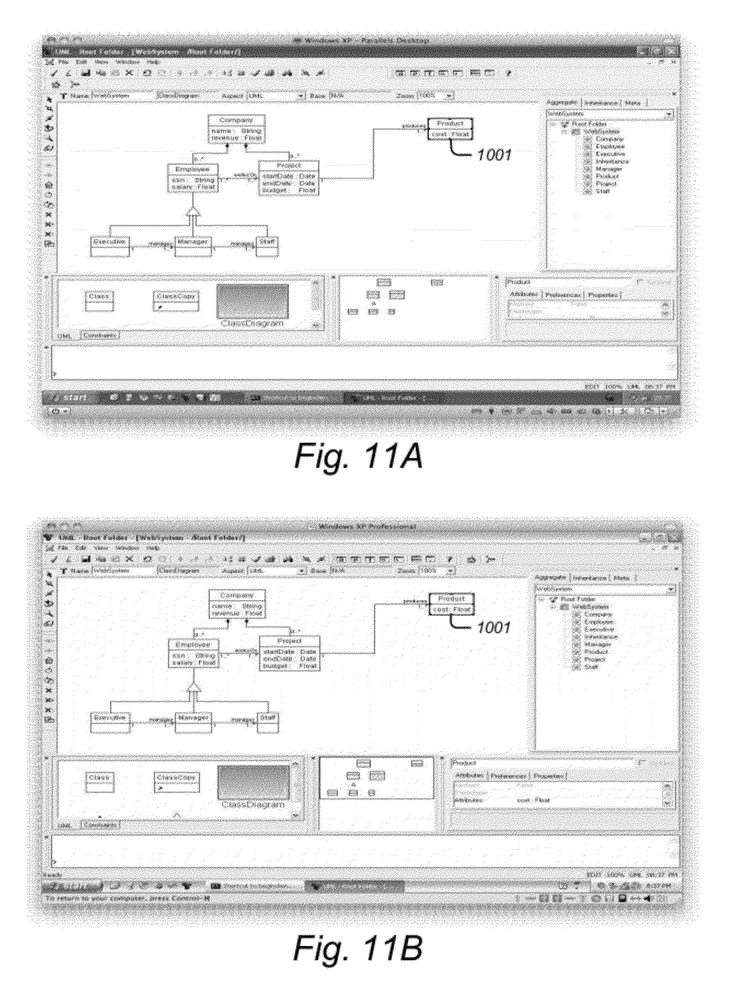

FIG. 11A illustrates the screen on the first client, after an architect of the first client has moved the position of the design element 1001.

FIG. 11B illustrates the screen on the second client after the movement of the design element 1001 that was made by the architect of the first client has been determined by the conflict detection software modeling server illustrated in FIG. 4 not to create a conflict.

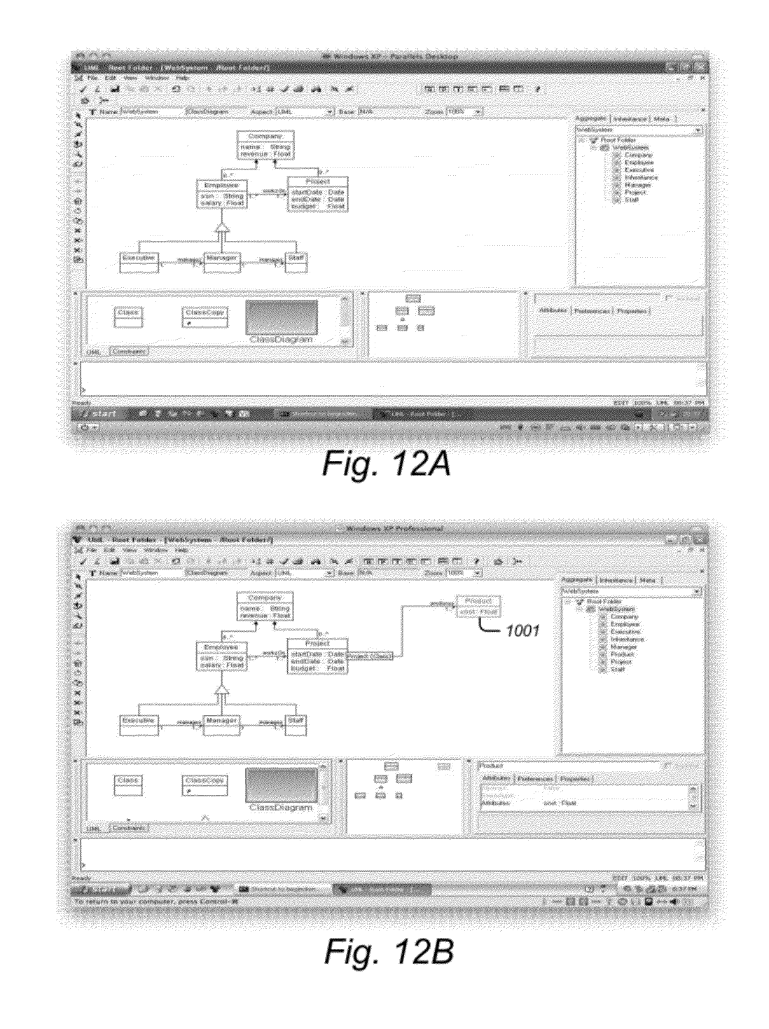

FIG. 12A illustrates the screen on the first client after an architect has removed the design element 1001.

FIG. 12B illustrates the screen on the second client, before the deletion of the design element that was removed by the architect on the first client has been determined not to create a conflict by the server illustrated in FIG. 4.

The second client may next request that the removed design element 1001 be moved, since it does not yet know that this would create a conflict. This may result in the issuance of a conflict notification by the conflict detection software modeling server.

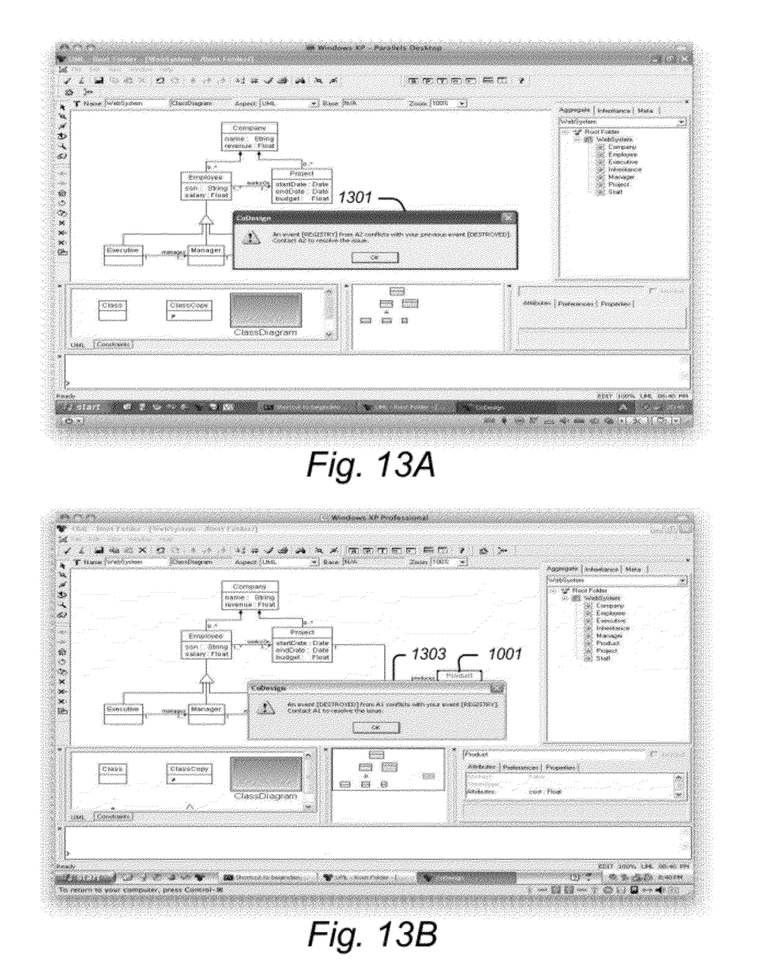

FIG. 13A illustrates a conflict notification 1301 on the screen of the first client after the architect on the second client moved the removed design element 1001. FIG. 13B illustrates a conflict notification 1303 on the screen on the second client after the architect on the second client moved the removed design element 1001.

FIG. 14 illustrates a report that the server that is illustrated in FIG. 4 may display after detection of the conflict illustrated in FIGS. 13A and 13B. The screen illustrates the message contents that include detailed information regarding the change, the detected conflict and the information regarding the conflict, and the issuance of the two conflict notices sent to the involved clients.

Unless otherwise indicated, the clients and servers that have been discussed herein, including their respective modules, may each be implemented with a computer system configured to perform the functions that have been described herein for them, including each of their components. Each computer system includes one or more processors, memory devices (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system may be a personal computer, mainframe, workstation, single user system, multi-user system, server, portable computer, hand-held device, cell phone, smartphone, tablet, or part of a larger system, such a vehicle, appliance, and/or telephone system.

Each computer system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

For example, the event/update connector may be configured to perform other functions, such as to time stamp each event. Similarly, the Prism connector 411 may be configured to perform other functions, such as to manage the login through the login GUI 413, and/or to add information about the architect and/or the model being worked on to each event. The architect management module 404 may be configured to authenticate each architect and to manage the database of architects that is stored in the architect database 417. A single server may be configured to detect conflicts in multiple models, each being worked on by the same or a different set of architects. One or more of the conflict detection modules, such as the synchronization detection module, may instead be located within the client or within a separate physical machine.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A software modeling client comprising:
a server communication module configured to communicate with a remote conflict detection software modeling server;
a modeling module configured to enable an architect to design and edit a model of computer software, the modeling module including a user interface configured to allow the architect to view the model, to request changes to the model, and to view the model with changes made to it; and
an event detection module configured to detect each change to the model that the architect requests and to cause the server communication module to communicate information about each change to the remote conflict detection software modeling server,
whereby the modeling module is also configured to:
add each approved change to the model of computer software that is made by a different software modeling client, as specified by a notification that the server communication module receives from the remote conflict detection software modeling server; and
remove or block each change to the model that the architect made using the modeling module that creates a conflict, as specified by a notification that the server communication module receives from the remote conflict detection software modeling server.

2. The client of claim 1 further comprising an event queue configured to temporarily store information about each change that is detected by the event detection module until information about the change is communicated to the server.

3. The client of claim 1 wherein the event detection module includes an event filter module configured to filter the events that are detected by the event detection module according to filter criteria so as to eliminate one or more types of events from those that about which information is communicated to the remote conflict detection software modeling server.

4. The client of claim 1 wherein the event detection module is configured to communicate with the modeling module through one or more APIs in the modeling module.

5. The client of claim 1 wherein the notification specifying a conflict from the server includes information identifying the architects that are involved with the conflict, elements in the model that would conflict, and the actions that caused the conflict.

6. A conflict detection software modeling server comprising:
a client communication module configured to communicate with multiple software modeling clients that are each designing a model of computer software and to receive information about changes to the model of computer software from each of the software modeling clients;
a conflict detection module configured to:
receive information about the changes to the model of computer software from the client communication module;
determine whether each change would cause a conflict;
when a change is determined not to cause a conflict, cause the client communication module to communicate information about the change to the software modeling clients that did not send the information about the change to the conflict detection software modeling server;
when a change is determined to cause a conflict, cause the client communication module to communicate to the software modeling client that did send the information about the change to the conflict detection software modeling server that the change causes a conflict.

7. The server of claim 6 wherein the conflict detection module is configured to determine whether a conflict exists based on a set of programmable rules.

8. The server of claim 6 wherein the conflict detection module is configured to determine that a change causes a conflict when the change causes a synchronization conflict.

9. The server of claim 6 wherein the conflict detection module is configured to determine that a change causes a conflict when the change causes a syntactic conflict.

10. The server of claim 6 wherein the conflict detection module is configured to determine that a change causes a conflict when the change causes a semantic conflict.

11. The server of claim 6 wherein the conflict detection module includes a plurality of conflict detection sub-modules, each configured to determine whether a change causes a conflict of a particular type, and wherein the conflict detection module is configured to aggregate the results from the conflict detection sub-modules.

12. The server of claim 6 wherein the communication that a change causes a conflict includes information identifying the architects involved with the conflict, elements of the model that are involved with the conflict, and the actions that caused the conflict.

13. The server of claim 6 further comprising a conflict resolution module configured to automatically resolve at least certain types of conflicts.

14. The server of claim 13 wherein the conflict resolution module is configured to automatically resolve the certain types of conflicts based on programmable rules.

15. The server of claim 6 further comprising an architect database configured to store information identifying architects or clients that have registered with the server to modify the model.

16. Non-transitory, tangible, computer-readable storage media containing a program of instructions configured to cause a computer system running the program of instructions to function as a software modeling client that performs the following process:
detects when an architect requests changes to a model of computer software;
communicates information to a remote conflict detection software modeling server about each change to the model that is detected;
adds each approved change to the model of computer software that is made by a different software modeling client, as specified by a notification from the remote conflict detection software modeling server; and
remove or block each change to the model that the architect made using the modeling module that creates a conflict, as specified by a notification from the remote conflict detection software modeling server.

17. The media of claim 16 wherein the program of instructions is configured to cause the computer system running the program of instructions to temporarily store information about each change that is detected in a queue until information about the change is communicated to the remote conflict detection software modeling server.

18. Non-transitory, tangible, computer-readable storage media containing a program of instructions configured to cause a computer system running the program of instructions to function as a conflict detection software modeling server that performs the following process:
receive information about changes to a model of computer software, each from one of multiple software modeling clients that are designing the model;
determine whether each change would cause a conflict;
when a change is determined not to cause a conflict, communicate information about the change to the software modeling clients that did not send the information about the change to the conflict detection software modeling server; and
when a change is determined to cause a conflict, communicate to the software modeling client that did send the information about the change to the conflict detection software modeling server that the change causes a conflict.

19. The media of claim 18 wherein the program of instructions is configured to cause the computer system to filter the events that are detected according to filter criteria so as to eliminate one or more types of events about which information is communicated to the remote conflict detection software modeling server.
